(19) United States
(12) Patent Application Publication
(10) Pub. No.: US 2026/0364635 A1
(43) Pub. Date: Nov. 19, 2026

(54) ULTRASONIC TRANSDUCER

(71) Applicant: QISDA CORPORATION, Taoyuan City (TW)

(72) Inventor: FU-SHENG JIANG, Taoyuan City (TW)

(21) Appl. No.: 19/672,749

(22) Filed: May 11, 2026

(30) Foreign Application Priority Data
May 16, 2025 (TW) 114118376

(51) Int. Cl. B06B 1/06

(52) U.S. Cl. CPC B06B 1/0629; B06B 2201/55

(57) ABSTRACT

An ultrasonic transducer includes an ultrasonic generation module and a backing adhesive layer. The ultrasonic generation module has a first surface, and a plurality of first grooves are formed on the first surface of the ultrasonic generation module. The first grooves are arranged parallel to and spaced apart from each other. The backing adhesive layer is disposed on the first surface and fills the first grooves. The ultrasonic generation module is configured to vibrate to generate an ultrasonic wave, and the ultrasonic wave is transmitted to the backing adhesive layer. The ultrasonic wave has a center frequency and propagates through the backing adhesive layer at a sound velocity to have a wavelength. A spacing between any two adjacent ones of the first grooves is an odd multiple of one half of the wavelength.

### CROSS-REFERENCE TO RELATED PATENT APPLICATION

This application claims the benefit of priority to Taiwan Patent Application No. 114118376, filed on May 16, 2025. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to an ultrasonic transducer, and more particularly to an ultrasonic transducer for improving signal-to-noise ratio.

### BACKGROUND OF THE DISCLOSURE

Ultrasonic transducer structures can generally be classified into two major categories: one category being ultrasonic transducers fabricated using microelectromechanical systems (MEMS) processing technology such as piezoelectric micromachined ultrasonic transducers (PMUTs) and capacitive micromachined ultrasonic transducers (CMUTs), and the other category being conventional ultrasonic transducers composed of piezoelectric ceramics or single crystals.

The conventional ultrasonic transducer usually includes a piezoelectric material layer and a backing adhesive layer. The backing adhesive layer is required to have an acoustic impedance close to that of the piezoelectric material and high attenuation, so as to effectively absorb residual acoustic waves from the piezoelectric material layer, reduce delayed echoes and noise, and improve energy absorption efficiency and signal clarity by lowering the interface reflectivity. To achieve the above acoustic performance, common backing adhesive materials are epoxy resin composites mixed with high-density metal powders. However, such composite materials are relatively difficult in manufacturing process. The mixing and distribution of the metal powders need to be precisely controlled to avoid uneven material properties. Moreover, since the metal powder is conductive, uneven distribution or improper thickness control may cause electrical short circuits, thereby affecting the stability and lifespan of the transducer.

On the other hand, the MEMS ultrasonic transducers (PMUTs/CMUTs) may generate a substrate ringing phenomenon during operation. The substrate ringing phenomenon refers to a situation where, when the vibrating membrane in a MEMS ultrasonic transducer is driven to produce ultrasonic vibrations, a part of the vibration is transmitted to the substrate, such that the substrate produces unintended mechanical vibrations due to its elastic mechanical properties. These residual vibrations cannot attenuate immediately and generate delayed echoes or noise within the device.

### SUMMARY OF THE DISCLOSURE

In response to the above-referenced technical inadequacies, the present disclosure provides an ultrasonic transducer to address the problem of a backing layer material in existing ultrasonic transducers being difficult to fabricate and having unstable acoustic performance.

In order to solve the above-mentioned problems, one of the technical aspects adopted by the present disclosure is to provide an ultrasonic transducer, which includes an ultrasonic generation module and a backing adhesive layer. The ultrasonic generation module has a first surface, and a plurality of first grooves are formed on the first surface of the ultrasonic generation module. The first grooves are arranged parallel to and spaced apart from each other. The backing adhesive layer is disposed on the first surface and fills the first grooves. The ultrasonic generation module is configured to vibrate for generating an ultrasonic wave, and the ultrasonic wave is transmitted to the backing adhesive layer. The ultrasonic wave has a center frequency and propagates through the backing adhesive layer at a sound velocity to have a wavelength. A spacing between any two adjacent ones of the first grooves is an odd multiple of one half of the wavelength.

Therefore, in the ultrasonic transducer provided by the present disclosure, by forming a plurality of first grooves on a first surface of the ultrasonic generation module facing the backing adhesive layer, destructive interference can occur when the ultrasonic wave generated by the ultrasonic generation module is transmitted to the backing adhesive layer, thereby reducing noise energy from the back side through mutual cancellation and improving the signal-to-noise ratio (SNR).

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic view of an ultrasonic transducer according to a first embodiment of the present disclosure in use;

FIG. 2 is a schematic enlarged view of part II of FIG. 1;

FIG. 3 is a schematic cross-sectional view of the ultrasonic transducer in a Y-Z plane according to the first embodiment of the present disclosure;

FIG. 4 is a schematic enlarged view of part IV of FIG. 3;

FIG. 5 is a schematic view of first grooves and second grooves being arranged on a substrate of the ultrasonic transducer according to the first embodiment of the present disclosure;

FIG. 6 is a schematic view of an ultrasonic transducer according to a second embodiment of the present disclosure; and

FIG. 7 is a schematic cross-sectional view of the ultrasonic transducer in a Y-Z plane according to the second embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

### First Embodiment

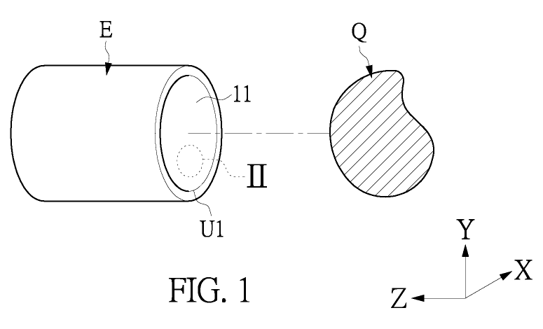

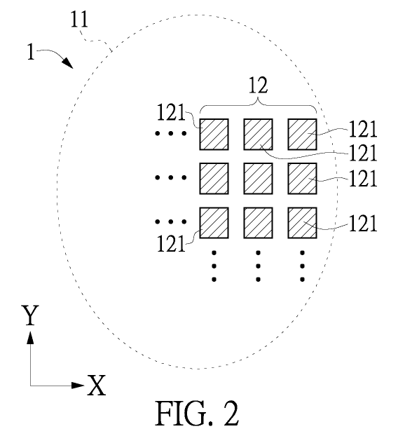

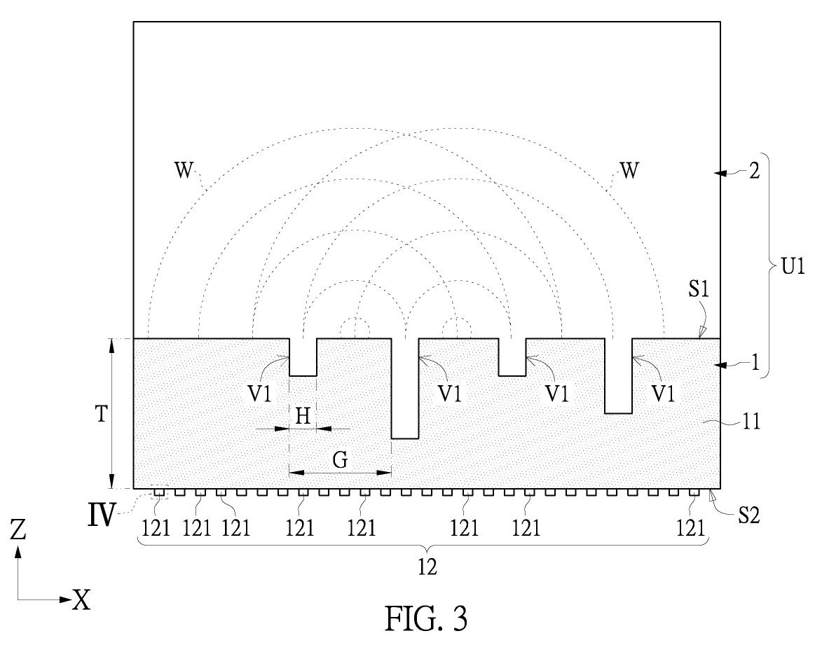

Reference is made to FIGS. 1 - 3. FIG. 1 is a schematic view of an ultrasonic transducer according to a first embodiment of the present disclosure in use. FIG. 2 is a schematic enlarged view of part II of FIG. 1. FIG. 3 is a schematic cross-sectional view of the ultrasonic transducer in a Y-Z plane according to the first embodiment of the present disclosure. A first embodiment of the present disclosure provides an ultrasonic transducer U1. For example, the ultrasonic transducer U1 can be mounted on a probe E, but the present disclosure is not limited thereto. The ultrasonic transducer U1 includes an ultrasonic generation module 1 and a backing adhesive layer 2. The ultrasonic generation module 1 has a first surface S1, and a plurality of first grooves V1 are formed on the first surface S1. The backing adhesive layer 2 is disposed on the first surface S1 and fills the first grooves V1.

In the first embodiment, the ultrasonic transducer U1 can be fabricated using a micro-electromechanical systems (MEMS) process technology. For example, the ultrasonic transducer U1 can be a piezoelectric micromachined ultrasonic transducer (PMUT) or a capacitive micromachined ultrasonic transducer (CMUT). Specifically, the ultrasonic generation module 1 includes a substrate 11 and a vibrating membrane module 12. The first surface S1 is a surface on one side of the substrate 11. In addition, the substrate 11 has a second surface S2 that is opposite to the first surface S1. The vibrating membrane module 12 is disposed on the second surface S2. The vibrating membrane module 12 includes a plurality of ultrasonic transducing elements 121. The ultrasonic transducing elements 121 can be arranged in a matrix configuration, so that the ultrasonic transducer U1 can perform a two-dimensional detection. It should be noted that the arrangement of the ultrasonic transducing elements 121 is not limited in the present disclosure.

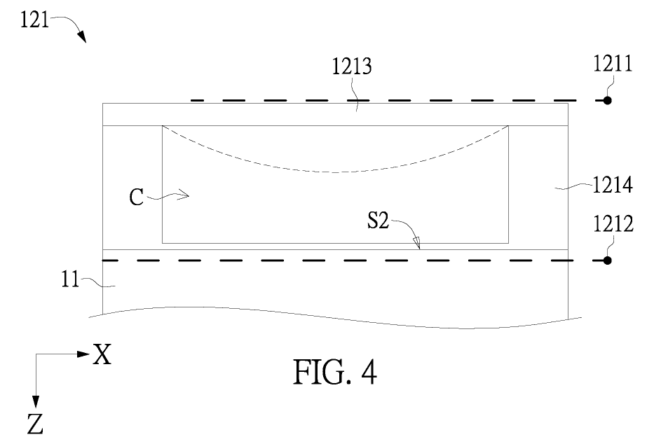

Reference is made to FIG. 4, which is a schematic view of an ultrasonic transducing element according to the first embodiment of the present disclosure. Each of the ultrasonic transducing elements 121 includes a first electrode unit 1211, a second electrode unit 1212, a membrane layer 1213, and an insulating support layer 1214. The insulating support layer 1214 is connected between the membrane layer 1213 and the substrate 11. The insulating support layer 1214 and the membrane layer 1213 jointly form a cavity C. The first electrode unit 1211 is disposed on the membrane layer 1213, and the second electrode unit 1212 is disposed on the substrate 11.

As shown in FIGS. 3 and 4, the ultrasonic transducer U1 can operate in both a transmitting mode and a receiving mode. In the transmitting mode, the first electrode unit 1211 and the second electrode unit 1212 of the ultrasonic transducing element 121 can be applied with voltage, so that the membrane layer 1213 can be driven to vibrate up and down relative to the cavity C, thereby generating ultrasonic waves radiated toward an external environment (e.g., an object Q to be tested in FIG. 1). The ultrasonic waves hit the object Q and are reflected to form reflected ultrasonic waves. On the other hand, in the receiving mode, the ultrasonic transducing element 121 receives the reflected ultrasonic waves transmitted from the external environment, causing the membrane layer 1213 to vibrate up and down again relative to the cavity C, such that the first electrode unit 1211 and the second electrode unit 1212 generate corresponding electrical signals according to the vibration of the membrane layer 1213, and then images are formed after signal processing.

Whether in the transmitting or receiving mode, when the membrane layer 1213 vibrates up and down, a part of the vibration energy (including the ultrasonic waves emitted outward or the ultrasonic waves reflected from the object Q) is simultaneously transmitted to the underlying substrate 11, causing the substrate 11 to generate unintended mechanical vibrations due to its elastic mechanical properties, which is referred to as substrate ringing. As shown in FIG. 3, vibrations caused by substrate ringing further radiate ultrasonic energy on the first surface S1 of the substrate 11 and transmit it to the backing adhesive layer 2. Since the ultrasonic energy originates from the undesired vibration of the substrate 11, it generates unexpected noise, thereby interfering with the received signal, reducing imaging clarity, and affecting the overall performance stability and image recognition accuracy of the ultrasonic transducer.

To suppress the noise, the first surface S1 of the substrate 11 forms a plurality of first grooves V1 thereon. The first grooves V1 generate destructive interference for an ultrasonic wave W transmitted from the substrate 11 to the backing adhesive layer 2, weakening the acoustic energy through phase cancellation and effectively reducing noise energy caused by substrate ringing. Through the design of the first grooves V1, the signal-to-noise ratio of the ultrasonic transducer U1 can be significantly improved, enhancing signal clarity and stability, and further improving image quality and system resolution.

As shown in FIG. 3, the plurality of first grooves V1 formed on the first surface S1 of the substrate 11 can be arranged periodically. More specifically, the first grooves V1 are parallel to each other and arranged at fixed intervals. For example, the backing adhesive layer 2 is made of epoxy resin. If the ultrasonic wave W has a center frequency f designed at 10 MHz and a measured sound velocity v of 2400 m/s in the backing adhesive layer 2, the corresponding wavelength λ of the ultrasonic wave W can be calculated by λ = v/f as 0.24 mm. Preferably, a spacing G between any two adjacent ones of the first grooves V1 is an odd multiple of one half of the wavelength λ, i.e., λ/2 = 0.12 mm, 3λ/2 = 0.36 mm, etc. The design of the spacing G facilitates destructive interference of the ultrasonic wave W transmitted from the substrate 11 to the backing adhesive layer 2, thereby weakening noise energy caused by substrate ringing. Furthermore, a width H of each of the first grooves V1 can be designed to be between about 0.005 mm and one quarter of the wavelength λ, so as to balance destructive interference and structural feasibility, thereby avoiding disadvantageous effects on the structural integrity of the substrate 11. In addition, the sound velocity v of the ultrasonic wave W varies with different materials being used for the backing adhesive layer 2 (e.g., 2520 m/s or 3000 m/s). Therefore, the sound velocity v mentioned in the present disclosure is not limited to the above-mentioned 2400 m/s.

Furthermore, the depths of the first grooves V1 can be equal or unequal to each other, and the present disclosure is not limited thereto. In the first embodiment, the first grooves V1 do not penetrate through the substrate 11. In a preferred embodiment, the depth of each of the first grooves V1 is set between one quarter and two thirds of a thickness T of the substrate 11. The thickness T is defined as a distance from the first surface S1 to the second surface S2 of the substrate 11. The design of the depths of the first grooves V1 can enhance the destructive interference and further improve the signal-to-noise ratio.

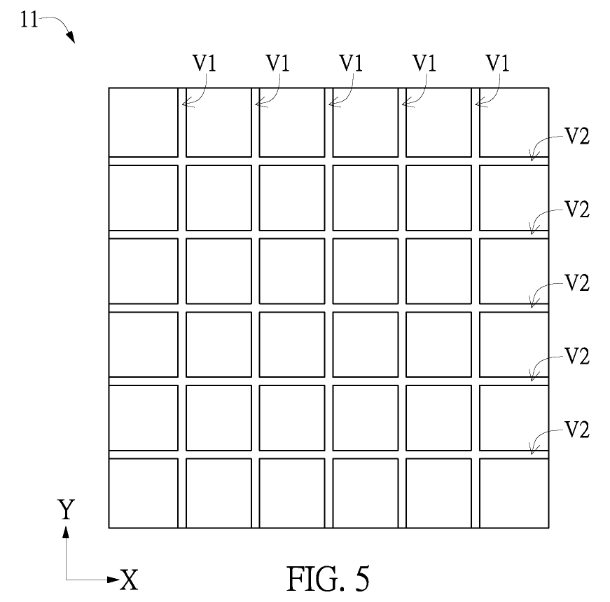

Reference is made to FIG. 5, which is a schematic view of first grooves and second grooves being arranged on a substrate of the ultrasonic transducer according to the first embodiment of the present disclosure. A plurality of second grooves V2 are formed on the first surface S1 of the substrate 11. The second grooves V2 are periodically arranged like the first grooves V1, and a spacing between any two adjacent ones of the second grooves V2 is set as an odd multiple of one half of the wavelength λ of the ultrasonic wave W. The second grooves V2 and the first grooves V1 are arranged in a staggered manner, and extending directions of the second grooves V2 are different from those of the first grooves V1. The second grooves V2 are also filled with the backing adhesive layer 2. Similarly, the second grooves V2 do not penetrate through the substrate 11, and the depth of each of the second grooves V2 is preferably between one quarter and two thirds of the thickness T of the substrate 11.

Preferably, the extending directions of the second grooves V2 are perpendicular to those of the first grooves V1, thereby forming a grid-like or cross-shaped groove structure. In other embodiments, the extending directions of the second grooves V2 can have a non-perpendicular angle with respect to those of the first grooves V1, thereby forming a diamond-shaped groove structure. Through this staggered configuration, the transmission paths of the ultrasonic wave from the substrate 11 to the backing adhesive layer 2 are further divided and disturbed, thereby generating destructive interference in more directions. In other words, this design can effectively disperse and attenuate noise energy generated by substrate ringing, further suppressing noise formation. As a result, the signal-to-noise ratio and imaging resolution of the ultrasonic transducer U1 can be significantly improved, enhancing its overall performance in imaging or detection applications.

### Second Embodiment

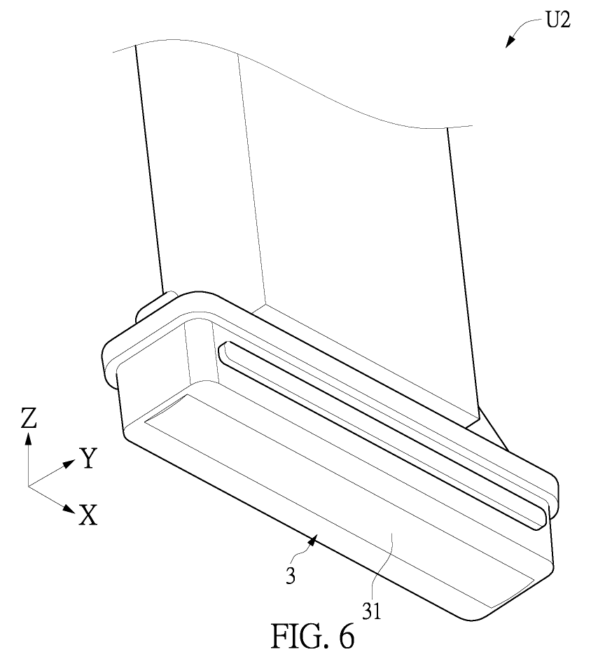

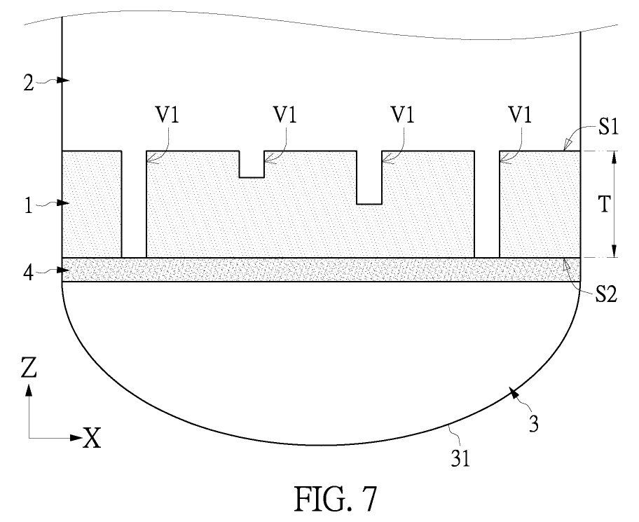

Reference is made to FIGS. 6 and 7. FIG. 6 is a schematic view of an ultrasonic transducer according to a second embodiment of the present disclosure, and FIG. 7 is a schematic cross-sectional view of the ultrasonic transducer in a Y-Z plane according to the second embodiment of the present disclosure. The second embodiment of the present disclosure provides an ultrasonic transducer U2, mainly including an ultrasonic generation module 1 and a backing adhesive layer 2. As shown in FIG. 7, the ultrasonic generation module 1 has a first surface S1, on which a plurality of first grooves V1 are formed. The backing adhesive layer 2 is disposed on the first surface S1 and fills the first grooves V1. In the second embodiment, the ultrasonic generation module 1 of the ultrasonic transducer U2 is a piezoelectric material layer that is made of PZT piezoelectric ceramic. In other words, the ultrasonic transducer U2 of the second embodiment is a conventional ultrasonic transducer structure made of PZT piezoelectric ceramic.

It should be noted that the first surfaces S1 in the first and second embodiments correspond to the surfaces used in different ultrasonic generation technologies, respectively. In the first embodiment, the ultrasonic transducer U1 is fabricated using a MEMS process technology, and its first surface S1 is the surface of the substrate 11. In the second embodiment, the ultrasonic transducer U2 is made of PZT piezoelectric ceramic, and its first surface S1 is the surface of the piezoelectric material layer.

The ultrasonic generation module 1 has a second surface S2 that is opposite to the first surface S1. In addition, the ultrasonic transducer U2 further includes an acoustic lens layer 3 and a matching layer 4. The acoustic lens layer 3 is disposed on the second surface S2 of the ultrasonic generation module 1 (i.e., the piezoelectric material layer), and the matching layer 4 is disposed between the acoustic lens layer 3 and the ultrasonic generation module 1. The acoustic lens layer 3 is also referred to as an acoustic lens. For example, the acoustic lens layer 3 can be a convex lens made of epoxy resin, and the material of the matching layer 4 may include a composite material formed by mixing polymer resin and hollow powder, but the present disclosure is not limited thereto.

The matching layer 4 is mainly configured to provide impedance matching with the ultrasonic generation module 1, thereby reducing reflection during the transmission of the ultrasonic wave and improving ultrasonic energy transfer efficiency. When operating the ultrasonic transducer U2, a curved surface 31 of the acoustic lens layer 3 is configured to be in contact with a human body surface. After the ultrasonic generation module 1 is energized, it vibrates to generate ultrasonic waves. The ultrasonic waves are transmitted through the matching layer 4 to the acoustic lens layer 3, and then transmitted through the acoustic lens layer 3 into the human body for object detection and image recognition.

Preferably, the depth of each of the first groove V1 does not exceed the thickness T of the ultrasonic generation module 1. A thickness T of the ultrasonic generation module 1 is defined as a distance from the first surface S1 to the second surface S2. When the depth of the first grooves V1 equals the thickness T, it means that the first grooves V1 penetrate through the first surface S1 and the second surface S2 (i.e., just cutting through the substrate 11).

The ultrasonic waves generated by the ultrasonic generation module 1 are primarily transmitted from the second surface S2 to the matching layer 4, and then transmitted through the acoustic lens layer 3 and enter human tissue for image scanning. However, a portion of the ultrasonic waves is also transmitted from the first surface S1 to the backing adhesive layer 2. The ultrasonic waves transmitted from the first surface S1 to the backing adhesive layer 2 can generate reflection and scattering, thereby causing undesired noise signals that affect the signal-to-noise ratio and image quality of the transducer. Therefore, the first surface S1 of the ultrasonic generation module 1 forms a plurality of first grooves V1 thereon. These first grooves V1 are configured to produce destructive interference for the ultrasonic waves transmitted to the backing adhesive layer 2. By adjusting the spacings and the depths of the first grooves V1, phase cancellation occurs between the ultrasonic waves transmitted to the backing adhesive layer 2, thereby weakening the acoustic energy. This design not only significantly suppresses noise energy caused by substrate ringing but also improves the signal-to-noise ratio of the ultrasonic transducer U2, further enhancing signal clarity and stability, and ultimately improving image quality and system resolution.

Furthermore, in the second embodiment, the ultrasonic generation module 1 of the ultrasonic transducer U2 can additionally form a plurality of second grooves V2 on the first surface S1 in addition to the first grooves V1. The second grooves V2 are periodically arranged, and a spacing between any two adjacent ones of the second grooves V2 is designed as an odd multiple of one half of the wavelength λ of an ultrasonic wave W generated from the ultrasonic generation module 1.

As shown in FIG. 5, although FIG. 5 illustrates the groove arrangement on the substrate 11 of the first embodiment, it is also applicable to the groove arrangement on the piezoelectric material layer of the ultrasonic generation module 1 in the second embodiment. The second grooves V2 and the first grooves V1 are arranged in a staggered manner, and extending directions of the second grooves V2 are different from those of the first grooves V1. Preferably, the extending directions of the second grooves V2 are perpendicular to those of the first grooves V1, thereby forming a grid-like or cross-shaped groove structure on the first surface S1. Alternatively, the extending directions of the second grooves V2 and the first grooves V1 can form a non-perpendicular angle, thereby creating a diamond-shaped groove arrangement.

Through this multi-directional staggered groove structure design, the surface coverage of the groove structure is increased, and the transmission paths of the ultrasonic waves transmitted from the ultrasonic generation module 1 to the backing adhesive layer 2 are divided and disturbed in more directions, which can further effectively suppress noise formation in the backing adhesive layer 2. Therefore, the efficiency of destructive interference is enhanced, and the signal-to-noise ratio and imaging performance of the transducer are improved. In addition, the second grooves V2 are filled with the backing adhesive layer 2 like the first grooves V1, which helps absorb acoustic energy and prevents it from being transmitted back to the ultrasonic transducer to form noise.

### Beneficial Effects of the Embodiments

In summary, the staggered grooves (the first grooves V1 and the second grooves V2) are formed on the first surface S1 of the ultrasonic generation module 1 facing the backing adhesive layer 2, so that destructive interference is generated when the ultrasonic waves generated by the ultrasonic generation module 1 are transmitted to the backing adhesive layer 2. As a result, noise energy can be weakened through mutual cancellation, and the signal-to-noise ratio can be improved. In addition, the multi-directional staggered groove structure design provided by the present disclosure is applicable to both micromachined ultrasonic transducers (i.e., the ultrasonic transducer U1 of the first embodiment) and conventional ultrasonic transducers (the ultrasonic transducer U2 of the second embodiment).

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An ultrasonic transducer, comprising:
an ultrasonic generation module having a first surface, the ultrasonic generation module forming a plurality of first grooves on the first surface, the first grooves being arranged parallel to and spaced apart from each other; and
a backing adhesive layer disposed on the first surface and filling the first grooves;
wherein the ultrasonic generation module is configured to vibrate to generate an ultrasonic wave that is transmitted to the backing adhesive layer, the ultrasonic wave has a center frequency, the ultrasonic wave propagates through the backing adhesive layer at a sound velocity to have a wavelength, and a spacing between any two adjacent ones of the first grooves is an odd multiple of one half of the wavelength.

2. The ultrasonic transducer according to claim 1, wherein the ultrasonic generation module includes a substrate and a vibrating membrane module, the substrate has a second surface that is opposite to the first surface, and the vibrating membrane module is disposed on the second surface; and wherein, when the vibrating membrane module vibrates to generate the ultrasonic wave, the ultrasonic wave is transmitted through the substrate to the backing adhesive layer.

3. The ultrasonic transducer according to claim 2, wherein the substrate has a thickness that is defined as a distance from the first surface to the second surface, and a depth of each of the first grooves is between one quarter and two thirds of the thickness.

4. The ultrasonic transducer according to claim 1, wherein a width of each of the first grooves is between 0.005 mm and one quarter of the wavelength.

5. The ultrasonic transducer according to claim 1, wherein the ultrasonic generation module further forms a plurality of second grooves on the first surface, the second grooves and the first grooves are arranged in a staggered manner, and an extending direction of the second grooves is different from that of the first grooves.

6. The ultrasonic transducer according to claim 5, wherein the extending direction of the second grooves is perpendicular to that of the first grooves.

7. The ultrasonic transducer according to claim 2, wherein the vibrating membrane module includes a plurality of ultrasonic transducing elements, each of the ultrasonic transducing elements includes a membrane layer and an insulating support layer, the insulating support layer is connected between the membrane layer and the substrate, and the insulating support layer and the membrane layer jointly form a cavity.

8. The ultrasonic transducer according to claim 7, wherein each of the ultrasonic transducing elements further includes a first electrode unit and a second electrode unit, the first electrode unit is disposed on the membrane layer, and the second electrode unit is disposed on the substrate; and wherein the first electrode unit and the second electrode unit are applied with voltage, such that the membrane layer vibrates up and down relative to the cavity to generate the ultrasonic wave.

9. The ultrasonic transducer according to claim 8, wherein the ultrasonic transducing element is configured to receive a reflected ultrasonic wave transmitted from an external environment, such that the membrane layer vibrates up and down relative to the cavity, and the first electrode unit and the second electrode unit are configured to generate a corresponding electrical signal according to the vibration of the membrane layer.

10. The ultrasonic transducer according to claim 1, wherein the ultrasonic generation module is a piezoelectric material layer, the piezoelectric material layer vibrates to generate the ultrasonic wave, and the ultrasonic wave is transmitted to the backing adhesive layer.

11. The ultrasonic transducer according to claim 10, wherein the ultrasonic generation module further has a second surface that is opposite to the first surface, the ultrasonic generation module has a thickness that is defined as a distance from the first surface to the second surface, and a depth of each of the first grooves does not exceed the thickness.

12. The ultrasonic transducer according to claim 11, wherein, when the depth of each of the first grooves is equal to the thickness, each of the first grooves penetrates through the first surface and the second surface.

13. The ultrasonic transducer according to claim 12, further comprising:
an acoustic lens layer disposed on the second surface of the piezoelectric material layer; and
a matching layer disposed between the acoustic lens layer and the piezoelectric material layer.
